(19) United States
(12) Patent Application Publication
(10) Pub. No.: US 2018/0077029 A1
(43) Pub. Date: Mar. 15, 2018

(54) MANAGING COST RELATED TO USAGE OF CLOUD RESOURCES

(71) Applicant: HEWLETT PACKARD ENTERPRISE DEVELOPMENT LP, Houston, TX (US)

(72) Inventors: Shruthi Mittal, Bangalore (IN); Bharat Gupta, Bangalore (IN)

(21) Appl. No.: 15/564,549

(22) PCT Filed: Jun. 5, 2015
(86) PCT No.: PCT/US2015/034472

§ 371 Date: Oct. 5, 2017

(30) Foreign Application Priority Data
Apr. 8, 2015 (IN) 1841/CHE/2015

(51) Int. Cl. H04L 12/24; H04L 12/16

(52) U.S. Cl. CPC H04L 41/18; H04L 41/5054; H04L 41/5096; H04L 41/14; H04L 41/5067; H04L 41/02; H04L 12/16

(57) ABSTRACT

Some examples describe managing cost related to usage of cloud resources. In an example, usage of a cloud resource by a user may be determined. Based on usage of the cloud resource, a recommendation for improving usage of the cloud resource may be provided to the user. Based on response from the user, an action related to the usage of the cloud resource may be performed.

### BACKGROUND

Cloud computing has evolved as an alternate model to regular computing operations of an enterprise. Generally speaking, cloud computing involves delivery of computing as a service rather than a product, whereby shared resources (software, storage resources, etc.) are provided to computing devices as a service. The resources are shared over a network, which is typically the internet. Cloud computing provides easy and scalable access to computing resources and information technology (IT) services.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing environment for managing cost related to usage of cloud resources;

FIG. 2 is a block diagram of an example computing system for managing cost related to usage of cloud resources;

FIG. 3 is a flowchart of an example method of managing cost related to usage of cloud resources; and

FIG. 4 is a block diagram of an example system for managing cost related to usage of cloud resources.

### DETAILED DESCRIPTION

Cloud computing is a delivery model for technology-enabled services that provides on-demand and pay-as-you-use access to an elastic pool of shared computing resources. Some examples of such resources may include applications, servers, storage, networks, etc. Cloud computing allows rapid provisioning of computing resources that could be scaled up or down depending on the requirements of a customer. Thus, these assets may be consumed “as a service”.

There are many models of cloud computing such as Infrastructure-as-a-Service (IaaS), Platform-as-a-Service (PaaS) and Software-as-a-Service (SaaS). Depending on a client's requirement, a cloud service provider may provide either of the aforementioned services, each of which may require provisioning of certain resources on a cloud. For instance, in case of a client request for deployment of an application (for example, an email application) on a cloud, a cloud service provider may provision infrastructure resources (for example, a virtual server) and platform resources in order to deploy the application.

A user's use of cloud-based resources may vary over time. For instance, a customer may request additional resources (for example, storage resources, processing resources, network resources, etc.) for various reasons, such as for meeting a Service Level Agreement (SLA), improving service performance, scalability, etc. Since cloud computing makes it easier for subscribers to provision computing resources almost instantly, there may be instances wherein after a period cloud resources of a subscriber may end up getting unutilized or underutilized. To provide an example scenario, depending upon immediate deliverables requirement, test engineers may request a large number of cloud resources to quickly deliver a product to the market or execute test cases where scalability and performance testing is required. Once this immediate infrastructure requirement is met through cloud computing, the subscriber may forget to release the additional cloud resources and, in some cases, may even request provisioning of further resources without realizing the presence of existing unutilized or underutilized resources. Needless to say, this is not desirable situation as it may unnecessarily burden a customer with additional costs.

To address such issues, the present disclosure describes various examples for managing cost related to usage of cloud resource. In an example, usage of a cloud resource by a user may be determined. Based on the usage of the cloud resource, a recommendation for improving usage of the cloud resource may be provided to the user. Based on the response received from the user, an action related to the usage of the cloud resource may be performed. In an example, the action may reduce cost of using the cloud resource for a customer.

As user herein, the term “user” may include a living entity (such as, an individual) or a non-living entity (such as, an enterprise, a business unit, an application, and the like). Also, the term “user” may be used interchangeably with the term “customer”.

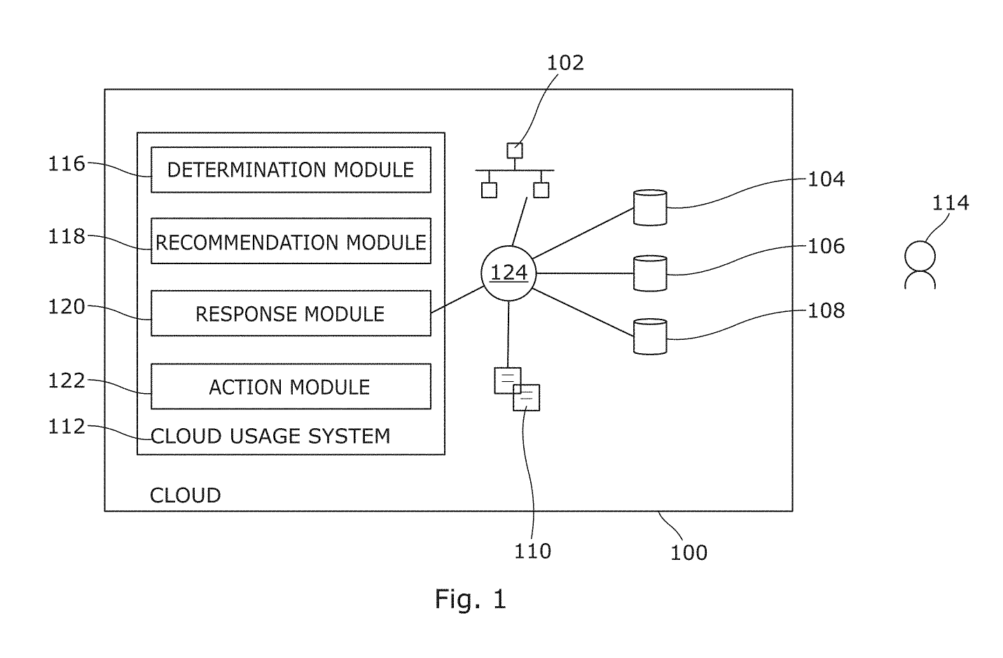

FIG. 1 is a block diagram of an example computing environment 100 for managing cost related to usage of cloud resources. In an example, computing environment 100 may include a cloud network or cloud system (“cloud”), which may be a private cloud, a public cloud, or a hybrid cloud. To explain briefly, a cloud system 100 may be termed as public cloud if cloud computing services are rendered over a public network such as the internet. On the other hand, a private cloud is a proprietary network that supplies services to a specific set of users. A hybrid cloud combines private and public cloud services. In an example, the computing environment 100 may include a plurality of cloud systems. In such case, the cloud systems may be provided by one cloud service provider or multiple cloud service providers.

Cloud system 100 may provide or deploy various types of cloud services for a user or customer. These may include Infrastructure as a Service (laaS), Platform as a Service (PaaS), Software as a Service (SaaS), and so forth. In order to provide an aforementioned service, a cloud may include various types of computing resources (i.e. “cloud resources”) such as 102, 104, 106, 108, and 110. These computing resources may be hardware resources, software resources, or any combinations thereof. For example, hardware resources may include computer systems, computer servers, workstations, or any other computer devices. And, software resources may include operating system software (machine executable instructions), firmware, and/or application software. Computing resources may also include virtual machines, virtual servers, storage resources, load balancers, firewalls, etc. The number of computing resources (102, 104, 106, 108 and 110) shown in FIG. 1 is for the purpose of illustration only and it may vary in other implementations.

Cloud system 100 may be used by a user or customer to request a new cloud resource and/or manage an existing cloud resource. Users may also use the cloud system 100 to view status of a pending cloud service request, pending approvals, and approved service subscriptions. Users may also use the cloud system 100 to request modifications in a cloud service subscription, cancel a cloud service subscription, and perform other actions related to their cloud services. In other words, cloud system 100 may be used to design, publish, and manage a cloud service(s).

Cloud system 100 may include a cloud usage system 112. Cloud usage system 112 may be any type of computing system capable of reading machine-executable instructions. These may include, without limitation, a computer server, a virtual server, a desktop computer, a notebook computer, a tablet computer, a thin client, a mobile device, a personal digital assistant (PDA), a phablet, and the like. In an example, cloud usage system may be present external to

[symbol]

In an example, cloud usage system 112 may be used to determine usage of a cloud resource by a user of the cloud system 100. Cloud usage system 112 may be communicatively coupled to the resources assigned to a user via a network 124, which may be a public network (for example, the Internet) or a private network (for example, an intranet). In the example of FIG. 1, cloud usage system may be communicatively coupled to virtual servers 104, 106, and 108 that may be assigned to user 114 of the cloud system 100.

In an example, cloud usage system 112 may include a determination module 116, a recommendation module 118, a response module 120, and an action module 122. The term “module” may refer to a software component (machine executable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computing device.

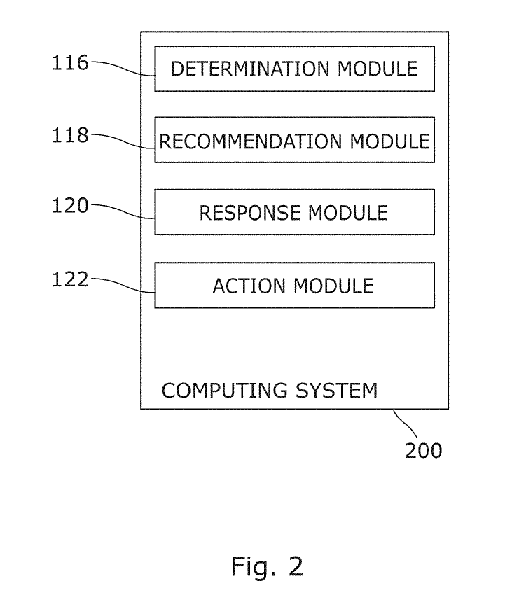

Some of the example functionalities that may be performed by determination module 116, recommendation module 118, response module 120, and action module 122 are described in reference to FIG. 2 below.

FIG. 2 is a block diagram of an example computing system 200 for managing cost related to usage of cloud resources. In an example, computing system 200 may be analogous to cloud usage system 112 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

Computing system 200 may be a server, a desktop computer, a notebook computer, a tablet computer, a mobile phone, a personal digital assistant (PDA), and the like.

In an example, computing system 200 may include may include a determination module 116, a recommendation module 118, a response module 120, and an action module 122.

Determination module 116 may determine usage of a cloud resource by a user of the cloud system (for example, 100). In other words, if a cloud resource is provisioned to a customer of a cloud system, determination module 116 may determine the amount of utilization of the cloud resource by the customer. For instance, referring to FIG. 1, determination module 116 may determine usage of server 104 by user 114. In another example, if the cloud resource is a computer application, determination module may determine number of licenses being used by a customer. In an instance, determining usage of a cloud resource by a user may include determining whether the cloud resource was accessed by the user in a pre-defined time period (for example, a week or a month). In an instance, this may include analyzing log-in data related to the cloud resource. If the cloud resource was accessed by a user during the pre-defined period, it indicates that the cloud resource is being used by the user. In another example, determining usage of a cloud resource may include determining utilization of various sub-elements or components of the cloud resource by a user. Such components may include, by way of example, a processing component (for example, CPU usage), a storage component, a memory component, and a networking component of the cloud resource. Determination module 116 may determine whether a cloud resource is fully utilized, partially utilized, underutilized, or unutilized by a user of the cloud system (for example, 100). In the event, a cloud resource is unutilized or underutilized; determination module 116 may tag the cloud resource. In an example, in case multiple cloud resources are provisioned to a user of a cloud system(s), determination module 116 may determine the extent of utilization of one or more of such cloud resources by the user.

Once determination module 116 determines usage of a cloud resource(s) by a user of the cloud system, recommendation module 118 may provide the usage information to the user. For instance, if determination module 116 identifies an unutilized or underutilized cloud resource of a customer, recommendation module 118 may bring this aspect to the attention of the customer. For example, in the context of “software application” example mentioned earlier, recommendation module may provide license usage information to a user. The usage information may be communicated to a user through various means such as, but not limited to, a user interface, an email, an instant message, and the like. Recommendation module 118 may also, based on the usage of a cloud resource, make a recommendation(s) to improve utilization of the cloud resource to a user. The recommendation(s) may be communicated to a user through various means such as, but not limited to, a user interface, an email, an instant message, and the like. In an example, a recommendation to improve utilization of a cloud resource may be communicated to a user along with usage information of the cloud resource.

In an example, recommendation module 118 may recommend merging a cloud resource of a user with another cloud resource of the user. Such recommendation may be made for instance in case of an unutilized or underutilized cloud resource of a user. In an instance, recommendation module 118 may identify an unutilized or underutilized cloud resource of a user from the tag assigned thereto by determination module 116. In case, two or more cloud resources of a user are unutilized or underutilized, recommendation module 118 may advise the user to merge two or more cloud resources. For instance, if two servers of a subscriber are underutilized such that compute, network, memory, and the like requirements of both the servers may be satisfied by just one of them, the subscriber may be advised to merge the two resources. In another instance, in the context of “software application” example mentioned earlier, if it is determined that there are multiple servers running same application with underutilized license allowed count, the servers may merged to revoke one of the licenses.

In an instance, prior to recommending merging of a cloud resource with another cloud resource of a user, recommendation module 118 may obtain usage details of the another cloud resource of the user from determination module 116, and determine that sum of usage of the cloud resource and usage of the another cloud resource is less than a threshold value. A recommendation to merge two or more cloud resources of a customer may be provided if sum of usage of cloud resources, which are selected for merger, is less than a pre-defined threshold value.

Response module 120 may be used to receive a response from a user of a cloud resource. For instance, if recommendation module 118 makes a recommendation(s) related to utilization of a cloud resource to a user, response module 120 may be used to receive a user's response to the recommendation(s). Some of the non-limiting examples of a user's response may include a request to the cloud service provider to cancel a subscription related to the cloud resource, a request to delete the cloud resource, a request to suspend the cloud resource, a request to merge a cloud resource of a user with another cloud resource(s) of the user, and a request to maintain status quo related to the cloud resource.

Action module 122 may be used to perform, based on a user's response to a recommendation(s) provided by recommendation module, an action related to the usage of a cloud resource. Some of the non-limiting examples of actions that may be performed by action module 122 may include an action to cancel a subscription related to the cloud resource, an action to delete the cloud resource, an action to merge a cloud resource of a user with another cloud resource(s) of the user, and an action to suspend the cloud resource. To provide an example, if a customer accepts a recommendation to merge two or more of virtual server resources, action module may migrate data from one virtual server to the other virtual server. The virtual server that no longer holds any data may be cancelled or suspended. In an instance, an action performed by action module may result in reducing cost of using a cloud resource for a customer.

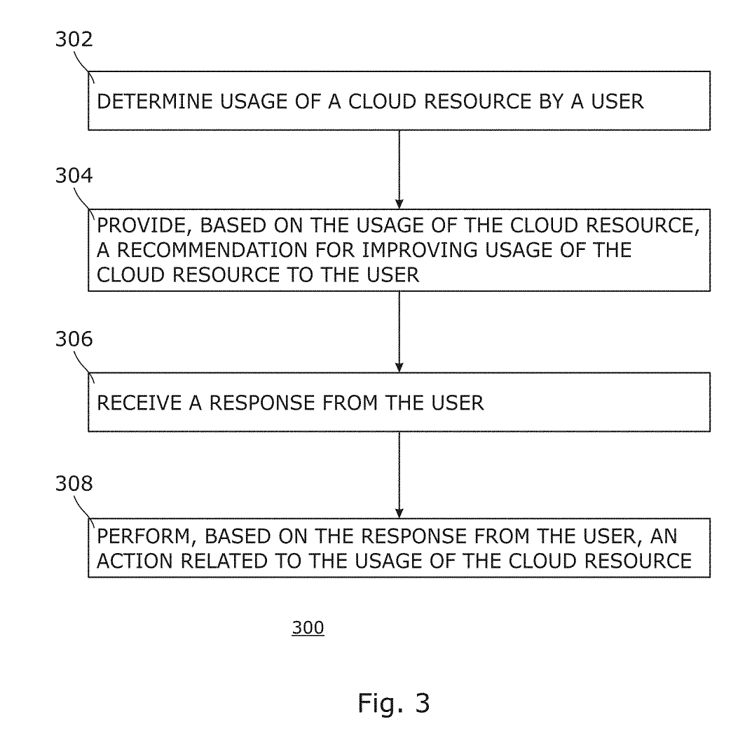

FIG. 3 is a flowchart of an example method 300 of managing cost related to usage of cloud resources. The method 300, which is described below, may be executed on a computing device such as cloud usage system 112 of FIG. 1 and computing system 200 of FIG. 2. However, other computing devices may be used as well. At block 302, usage of a cloud resource by a user may be determined. At block 304, based on the usage of the cloud resource, a recommendation may be provided for improving usage of the cloud resource to the user. At block 306, a response may be received from the user. At block 308, based on the response from the user, an action related to the usage of the cloud resource may be performed.

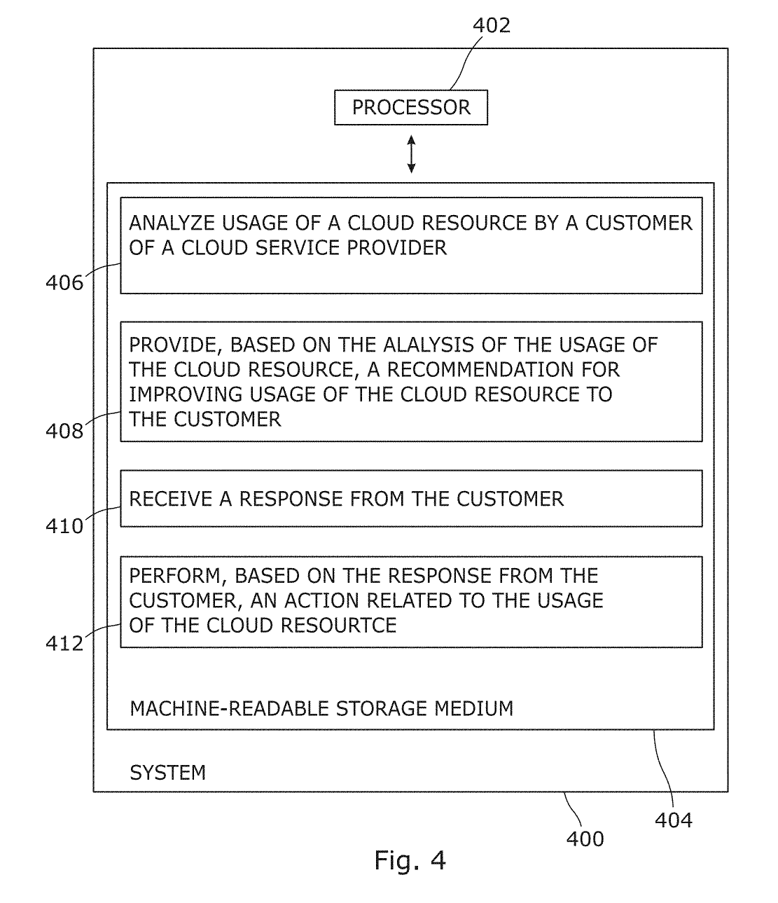

FIG. 4 is a block diagram of an example system 400 for managing cost related to usage of cloud resources. System 400 includes a processor 402 and a machine-readable storage medium 404 communicatively coupled through a system bus. In an example, system 400 may be analogous to cloud usage system 112 of FIG. 1 and computing system 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 404 may store instructions 406, 408, 410, and 412. In an example, instructions 406 may be executed by processor 402 to analyze usage of a cloud resource by a customer of a cloud service provider. Instructions 408 may be executed by processor 402 to provide, based on the analysis of the usage of the cloud resource, a recommendation for improving usage of the cloud resource to the customer. Instructions 410 may be executed by processor 402 to receive a response from the customer. Instructions 412 may be executed by processor 402 to perform, based on the response from the customer, an action that reduces cost of using the cloud resource for the customer.

For the purpose of simplicity of explanation, the example method of FIG. 3 is shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution.

1. A method of managing cost related to usage of cloud resources, comprising:
determining usage of a cloud resource by a user;
providing, based on the usage of the cloud resource, a recommendation for improving usage of the cloud resource to the user;
receiving a response from the user; and
performing, based on the response from the user, an action related to the usage of the cloud resource.

2. The method of claim 1, wherein the recommendation includes recommending merging of the cloud resource with another cloud resource of the user.

3. The method of claim 2, wherein the action includes merging the cloud resource with another cloud resource of the user.

4. The method of claim 3, wherein prior to recommending merging the cloud resource with another cloud resource of the user:
determining usage of the another cloud resource; and
determining that sum of usage of the cloud resource and usage of the another cloud resource is less than a threshold value.

5. The method of claim 1, further comprising providing information related to the usage of the cloud resource to the user.

6. The method of claim 1, wherein the action reduces cost of using the cloud resource for the user.

7. A system for managing cost related to usage of cloud resources, comprising:
a determination module to determine usage of a cloud resource by a user;
a recommendation module to provide, in response to a determination that the cloud resource is unutilized or underutilized, a recommendation to improve usage of the cloud resource to the user;
a response module to receive a response from the user; and
an action module to perform, based on the response, an action related to the usage of the cloud resource.

8. The system of claim 7, wherein the determination module to determine whether the cloud resource is accessed by the user within a pre-defined period.

9. The system of claim 7, wherein to determine usage of the cloud resource includes determining usage of a component related to the cloud resource, wherein the component includes one of a processing component, a memory component, a storage component, and a network component.

10. The system of claim 7, wherein the cloud resource is present in one of a private cloud, a public cloud, and a hybrid cloud.

11. The system of claim 7, wherein the cloud resource is provisioned to the user by a single cloud service provider or multiple cloud service providers.

12. A non-transitory machine-readable storage medium comprising instructions to manage cost related to usage of cloud resources, the instructions executable by a processor to:
analyze usage of a cloud resource by a customer of a cloud service provider;
provide, based on the analysis of the usage of the cloud resource, a recommendation for improving usage of the cloud resource to the customer;
receive a response from the customer; and
perform, based on the response from the customer, an action that reduces cost of using the cloud resource for the customer.

13. The storage medium of claim 12, wherein the response includes one of a request to cancel a subscription related to the cloud resource, a request to delete the cloud resource, and a request to suspend the cloud resource.

14. The storage medium of claim 12, wherein the action includes one of to cancel a subscription related to the cloud resource, to delete the cloud resource, and to suspend the cloud resource.

15. The storage medium of claim 12, wherein the cloud resource is a computer application.
